(19) United States
(12) Patent Application Publication
(10) Pub. No.: US 2003/0130040 A1
(43) Pub. Date: Jul. 10, 2003

(54) Distributed video game system and method

(76) Inventor: Jeffrey Thomas Dripps, Grapevine, TX (US)

Correspondence Address: Robert O. Groover III, Arter & Hadden LLP, (Patnet Docketing), 1100 Huntington Bldg. , 925 Euclid Ave., Cleveland, OH, 44115, US

(21) Appl. No.: 10/196,339

(22) Filed: Jul. 16, 2002

Related U.S. Application Data
(60) Provisional application No. 60/306,065, filed on Jul. 17, 2001.

(51) Int. Cl. A63F 13/00

(52) U.S. Cl. 463/42

(57) ABSTRACT

In accordance with an embodiment of the present invention, a method for rendering graphics image data in real-time for a plurality of game clients, comprises receiving a packet from a first one of the plurality of game clients, the packet comprising a packet header comprising a time-stamp of transmission of the packet from the first game client and a client time differential between a clock of the first game client and a clock of a game server; determining a time-stamp of reception of the packet by the game server; determining time taken by the packet to arrive from the first game client to the game server; rendering graphics image data based at least in part on the time taken by the packet to arrive at the game server; and providing the rendered graphics image data to a second one of the plurality of game clients.

### CROSS-REFERENCE TO RELATED APPLICATIONS

This patent application claims the benefit of Provisional Patent Application, Serial No. 60/306,065, entitled Motorsims Game System Network Architecture, filed on Jul. 17, 2001, the disclosure of which is incorporated herein by reference.

### TECHNICAL FIELD OF THE INVENTION

The present invention relates generally to the field of distributed gaming.

### BACKGROUND OF THE INVENTION

The use of video games has increased exponentially over the years and is expected to increase exponentially in the future. Traditional gaming systems require users to attach a game console to a monitor, insert a game cartridge in the console and then play the game. Games may also be played using computer systems by installing games from compact discs (CDs) into the hard drive of the computer system. In general, computer games are controlled by software code executed by the computer system.

Gaming systems have evolved over the years so that multiple users may play the same game and compete with each other. The users competing with each other are usually in the same room in close proximity to each other. Newer gaming systems allow users who are geographically distributed to compete with each other.

### SUMMARY OF THE INVENTION

In accordance with an embodiment of the present invention, a method for rendering graphics image data in real-time for a plurality of game clients comprises receiving a packet from a first one of the plurality of game clients, the packet comprising a packet header comprising a time-stamp of transmission of the packet from the first game client and a client time differential between a clock of the first game client and a clock of a game server; determining a time-stamp of reception of the packet by the game server; determining time taken by the packet to arrive from the first game client to the game server; rendering graphics image data based at least in part on the time taken by the packet to arrive at the game server; and providing the rendered graphics image data to a second one of the plurality of game clients.

In accordance with another embodiment of the present invention, a video game system comprises a game server operable to receive a first packet from a game client, the first packet comprising a packet header comprising a time-stamp of transmission of the first packet from the game client and a client time differential between the clock of the game client and the clock of the game server, the game server operable to: determine a time-stamp of reception of the first packet by the game server; determine time taken by the first packet to arrive from the game client to the game server; calculate a server time differential between the clock of the game client and same clock of the game server based at least in part on the time-stamp of reception of the first packet and at least in part on the time-stamp of transmission of the first packet; and transmit a second packet from the game server, the second packet comprising a packet header comprising a time-stamp of transmission of the second packet from the game server and the server time differential.

Other aspects and features of the invention will become apparent to those ordinarily skilled in the art upon review of the following description of specific embodiments of the invention in conjunction with the accompanying figures. BRIEF DESCRIPTION OF THE DRAWINGS

For a more complete understanding of the present invention, the objects and advantages thereof, reference is now made to the following descriptions taken in connection with the accompanying drawings in which:

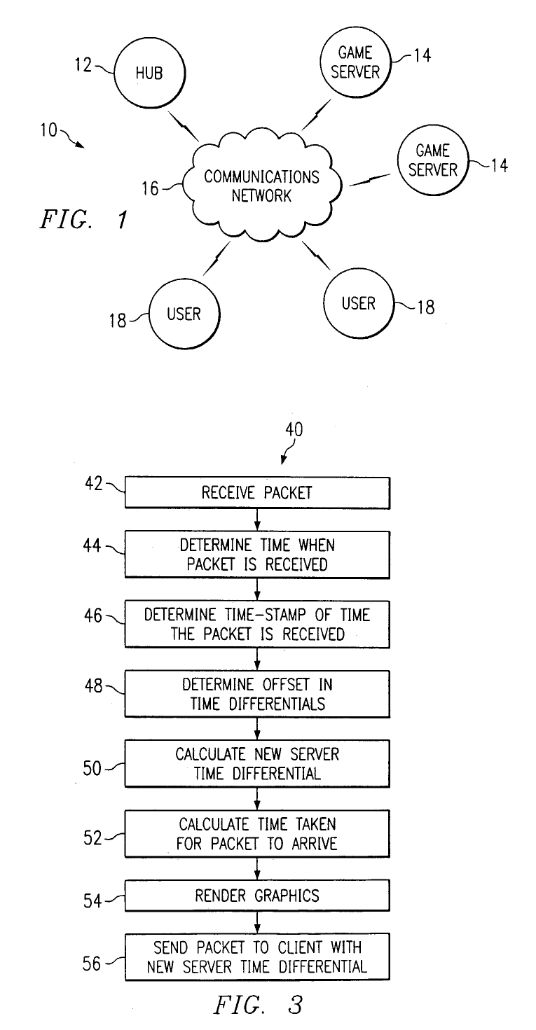

FIG. 1 is a logical diagram of a gaming environment in accordance with an embodiment of the present invention;

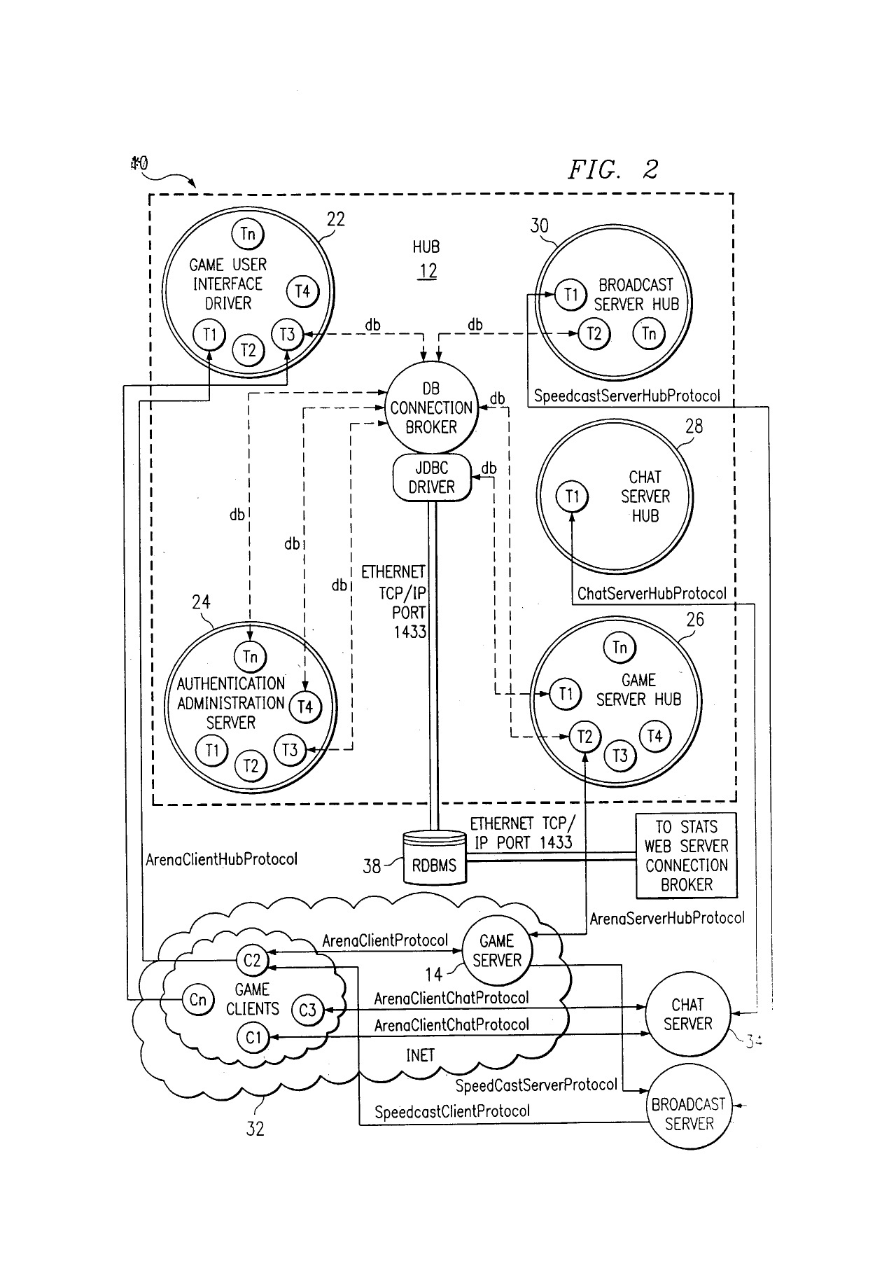

FIG. 2 is a detailed block diagram of a gaming environment in accordance with an embodiment of the present invention; and

FIG. 3 is a flowchart of a method for providing accurate real-time information to a plurality of users logged onto a gaming system in accordance with an embodiment the present invention.

### DETAILED DESCRIPTION OF THE DRAWINGS

The preferred embodiment of the present invention and its advantages are best understood by referring to FIGS. 1 through 3 of the drawings.

Multimedia systems, such as video game systems, have evolved such that multiple users may participate in the same event from different locations. Thus, for example, in a video game system, multiple users may play the same game and compete with each other from different locations. In such systems it is desirable that the most accurate information from each user's computer be transmitted to the other users in real-time. This is especially desirable in systems that support applications, such as real-time conferencing, car racing games, and/or the like, where accuracy of one thousandth of a second is desirable. Thus, there is a desire for a system and method that provides accurate real-time information to a plurality of users logged onto the system. Accordingly, a system and method is provided which utilizes one or more application servers, such as game servers, to provide accurate real-time information to a plurality of users logged onto the application server using applicant clients, such as game clients. In accordance with an embodiment of the present invention, when the application client initially connects to the application server, a clock of the application server is synchronized with a clock of the computer on which the application client is executing. Thereafter, clock synchronization is performed preferably with each exchange of data between the application server and the application client. Since multiple users may be participating in the same event, for example playing the same game, utilizing the same application server, the application server synchronizes its clock with the computers of each of the users. Since the application server has information on the clocks of the computers of each of the users, it is able to generate accurate real-time information, for example render graphics and provide the information to each user utilizing the application server.

For convenience, various aspects of the present invention, are described herein with reference to a video game system. However, the invention is not so limited and teachings of the present invention may be utilized in any application in which it is desirable to exchange accurate information in real-time.

FIG. 1 is a logical diagram of a gaming environment 10 in accordance with an embodiment of the present invention. In gaming environment 10, a hub 12 is provided. One or more game servers 14 communicate with hub 12 preferably via a communications network 16, such as the Internet. One or more users 18 may log-on to hub 12 and/or game servers 14 via communications network 16. User 18 may participate in one or more events hosted by game server 14. Preferably, the events supported by game server 14 relate to video games, such as drag racing, super bike racing, TRANSAM racing, and/or the like. User 18 may participate in an event at one or more of the following levels—player, spectator, and/or the like. As a “player”, user 18 may participate by playing one or more games hosted by game server 14 against other users logged onto the same game server. As a “spectator”, user 18 may participate by watching one or more games hosted by game server 14.

FIG. 2 is a detailed block diagram of gaming environment 10 in accordance with an embodiment of the present invention. Preferably, hub 12 comprises of one or more processes. Each process may comprise one or more threads. A database management system 38 may be provided to manage data related to the various users, game servers, and/or the like. Preferably, database management system 38 is a relational database management system (RDBMS).

In general, hub 12 is a central server. It authenticates one or more game clients 32 preferably via a game user interface driver 22. If desired, hub 12 may also authenticate and/or communicate with one or more game servers 14 preferably via a game server hub 26, one or more chat servers 34 preferably via a chat server hub 28 and one or more broadcast servers 36 preferably via a broadcast server hub 30. Preferably, game server hub 26 initializes game server 14 upon start-up, for example in the case of a game with the weather parameters, name of the game, etc. Game server 14 is programmed by game server hub 26 with relevant data from RDBMS 38. Preferably, game server 14 is also initialized at the end of every event.

Game client 32 is preferably a software program installed on a user's computer. Game client 32 enables a user to participate in an event supported by game server 14. Using game client 32, a user may logon to hub 12, preferably via game user interface driver 22. The user may be authenticated by authentication hub 24 using information stored in RDBMS 38. RDBMS 38 may also include information on one or more game servers 14, one or more chat servers 34 and one or more broadcast servers 36. Preferably, game client 32 comprises a graphical user interface (not shown) that allows a user to manipulate objects on a monitor associated with the user's computer and thus participate in the events. Preferably, the communication between game client 32 and game user interface driver 22 is via an arena client hub protocol specific to the particular game client. If desired, a generic arena client hub protocol may be used. In the embodiment illustrated in FIG. 2, game user interface driver 22 and game client 32 communicate directly. However, the invention is not so limited and if desired, a web applet client (not shown) may be provided which communicates with both game user interface driver 22 and game client 32.

Game server 14 hosts one or more events, such as games. Each event or game is hosted by one of the game servers 14. User 18 may participate in an event hosted by the game server. Also, user 18 may chat with other users logged onto the same game server via chat server 34. Chat server 34 broadcasts to users participating in the same event, anything said by any of the users. A single chat server 34 may support more than one event server.

Once game client 32 authenticates itself to hub 12, it receives information, such as a list of events currently being offered by game server 14 from game user interface driver 22. Preferably, for every event included in the list of events there is an instance of a corresponding game server 14 that's hosting the event. From the list of events, the user may select one or more events in which the user wants to participate. The user may simultaneously connect to one or more game servers 14 along with other users who may be connected to the same game servers. Upon connecting to game serer 14, user 18 preferably also connects to the corresponding chat server 34 that allows the user to communicate with other users participating in that event. Once the user is connected, the user may participate in the event being hosted by the game server.

Once the user is connected to game server 14, the hardware clocks on game server 14 and the computer of the user are synchronized so that the time differential of the clocks on the game client and game server 14 is within a predetermined time period, say 5 milliseconds. For this purpose, game client 32 and game server 14 exchange packets with time-stamps of when the packets were sent. The time-stamps are created based on a reference time, referred to herein as an epochMilliseconds. An epochMilliseconds is the number of milliseconds from a predetermined date, say Jan. 1, 1970, to the time when the game client 32 is started. The transport protocol layer time-stamps exactly what Month, Day, Year, Hour, Min, Second, Millisecond (and microsecond in hi-resolution mode) that the local clock is set to, in the header of each transmitted packet. As each new packet is sent between the game client and the game server, the time differential is halved. As such, a substantially accurate determination of the time on the game client or the game server may be obtained by the other. Game client 32 maintains a client time differential value for each of the game servers it is connected to and game server 14 maintains a server time differential value for each of the game clients connected to it. The client time differential is the time differential between the game client and the game server as perceived by the game client. The server time differential value is the time differential between the game client and the game server as perceived by the game server.

If the user has chosen to participate as a spectator, then the event for which the user has chosen to be a spectator may be broadcast to the user by broadcast server 36. Game server 14 receives data streams, for example audio and/or video streams, from the various users participating in an event as a player, combines them into a data stream to be broadcast to one or more users participating as “spectators” and provides the combined data stream to broadcast server 36. Broadcast server 36 broadcasts the combined stream to the users participating as “spectators” in the particular event. By providing a separate server to broadcast the event to spectators, the load on game server 14 hosting the event may be reduced. The data provided by game server 14 to broadcast server 36 comprises of data received from multiple users participating in the event as players.

If a user is participating in a game as a “player”, then game client 32 of the user may send packets of data to game server 14. Preferably, game server 14 receives packets of data from multiple game clients 32 participating in the same event. A packet of data may comprise a payload and a header. Based on the information stored in the header of a data packet, game server 14 determines the graphics to be rendered on the game clients of other users, renders the graphics and transmits the data to the users as packets.

While game client 32 is connected to game server 14, game client 32 and game server 14 exchange data packets. Each packet comprises a packet header that comprises a time-stamp, which is preferably 64 bits long. Each packet that leaves the game client is time-stamped with the time on game client 32 based on the real-time clock of the computer on which the game client is running. The time-stamp is preferably based on a reference time, such as epochMilliseconds. Each packet header also comprises a field, preferably 4 bytes, that includes the client time differential information for the game server for which the packet is intended.

FIG. 3 is a flowchart of a method 40 for providing accurate real-time information in accordance with an embodiment of the present invention. In step 42, game server 14 receives a packet with a time-stamp. In step 44, game server 14 determines the time the packet was received by game server 14. In step 46, the time-stamp of the time when the packet was received by game server 14 is calculated. In the preferred embodiment, this is calculated by adding a predetermined value, for example an epochMilliseconds, to the time the packet was received.

In step 48, the offset in time differentials as perceived by game client 32 and as perceived by game server 14 before the packet was transmitted by game client 32 is determined. Preferably, the offset in time differentials is given by the difference in time differentials between game client 32 and game server 14. In the preferred embodiment, this is calculated by subtracting the server time differential value stored in game server 14 from the client time differential information stored in the header of the received packet. In step 50, the new server time differential is calculated. In the preferred embodiment, the new server time differential is calculated by subtracting the time-stamp of the time the packet is received (determined in step 46) from the time-stamp included in the received packet. In step 52, the time taken for the packet to arrive at game server 12 is calculated. In the preferred embodiment, this is calculated by subtracting the newly calculated server time differential from the client time differential stored in the header of the received packet.

In step 54, based at least in part on information received from the packet, game server 14 generates information, such as graphics, to be transmitted to game clients 32. The generation of information by game server 14 comprises generating information based on packets received from other users. Thus, for example, if two users are playing against each other, then game server 14 renders the graphics to be displayed on each player's computer. In order to render graphics to be displayed on the first player's computer, game server 14 preferably utilizes information received from the second player and in order to render graphics to be displayed on the second player's computer, game server 14 preferably utilizes information received from the first player. Because game server 14 knows the time it took the packet from a game client to arrive at the game server and also knows the time differential in the clocks of the game server and the multiple computers executing the game clients, it is able to generate more accurate real-time information. Thus, game server 14 is able to accurately project the objects, for example racing car, of the game to the position it is supposed to be at any given time. Accordingly, game server 14 may accurately generate graphics image data and/or images in real-time.

In step 56, game server 14 transmits the information in the form of packets to the game clients participating as players. If desired, game server 14 may combine information from different game clients and transmit it to broadcast server 36 to be broadcast to users participating as spectators.

Each packet that leaves the game server is time-stamped with the time on game server based on the real-time clock of the game server. The time-stamp is preferably based on a reference time, such as epochMilliseconds. The transport protocol layer time-stamps exactly what Month, Day, Year, Hour, Min, Second, Millisecond (and microsecond in hi-resolution mode) that the local clock is set to, in the header of each transmitted packet. Each packet header also comprises a field, preferably 4 bytes, that includes the server time differential information for the game client for which the packet is intended.

The flowchart of FIG. 3 is preferably executed by game server 14 each time it receives a packet. Game client 32 executes steps similar to those executed by game server 14 each time it receives a packet. As such both game server 14 and game client 32 continuously synchronize their clocks and game server 14 is aware of the time differential between its own clock and that of each game client 32, allowing it to render graphics accurately in real-time.

Following is a more detailed description of some of the components of FIG. 2 in accordance with an exemplary embodiment of the present invention:

Hub 12

Hub 12 implements the logic that maintains and dictates the behavior of gaming environment 10. Changes to effect the behavior of the network are made through hub administration classes. Likewise, creation of a new online game is done via web form based interfaces. The game facilities (facility name, track name, alt., and weather data), event classes, vehicles, skill levels, categories, features, etc. are all created and maintained via these interfaces. Hub 12 may be viewed as the hub of a wagon wheel, to which many network entities (clients and servers) or spokes attach, to be authenticated, given instructions and to exchange information.

Hub 12 is the central controller of the gaming network and maintains state and data replication services for clients and/or servers in the network. For example, hub 12 maintains a list of customers that are connected to the network, what game they are in, what chat room and chat channel they are in, what time they connected, what state they are in, and/or the like. The hub also has information on the game servers available, the state of the game servers, the available chat servers, their state, and/or the like.

Among the network entities that communicate with the hub, via proprietary IP protocols are:

RDBMS Servers—for archival and retrieval of gaming related data

Web (HTTP) Browsers—for query and display of statistical data via the game clients

Web (HTTPS) Browsers—for secure query, viewing, editing or creation of customer and game event data

Game Servers—for server authentication, event registration, reservation, game play, and statistical logging.

Chat Servers—for textual and/or non-textual chat communications between network players

Broadcast Servers—for broadcasting of spectator feeds of live (real-time) game events

Game Clients—for client authentication, communication, event selection and game play and/or for spectator viewing of live (real-time) game events

The client and server applications communicate through a unique socket (port), have there own handler thread and associated logic within the hub, and communicate via their own application specific protocol. For example, RDBMS server 38 communicates with hub 12 over port 1433 via TDS (Tabular Data Stream) protocol through JDBC. The web server client communicates over port 80 using HTTP protocol. The web administration interface communicates over port 443 and uses HTTPS protocol. Game servers 14 communicate with game server hub 26 on port 4777 using a proprietary ArenaServerHubProtocol (ASP). Chat servers 34 use port 4780 using ArenaChatProtocol (ACP). Game clients 32 connect to port 4780 using ArenaClientHubProtocol (AHP). Broadcast servers 36 use port 4788 and use a proprietary SpeedCastServerProtocol (SSP). A list of the supported protocols is given in Table 1 below.

TABLE I

| | |
|---|---|
| SERVERS | |
| Game Server | Game Play |
| Chat Server | Communication |
| Broadcast Server | Spectator Video |
| CLIENTS | |
| Game Interface | Game Play |
| Web Interface | Event Selection |
| PROTOCOLS | |
| (ASHP) ArenaServerHubProtocol | Game Server -> Hub |
| | conversation |
| (CSHP) ChatServerHubProtocol | Chat Server -> Hub |
| | conversation |
| (ACHP) ArenaClientHubProtocol | Game Client -> Hub |
| | conversation |
| (SSHP) SpeedcastServerHubProtocol | Broadcast Server -> Hub |
| | conversation |
| (ASCP) AMASBSpeedcastClientProtocol | Broadcast Server -> AMASB |
| | Game Client conversation |
| (NSCP) NHRASpeedcastClientProtocol | Broadcast Server -> NHRA |
| | Game Client conversation |
| (TSCP) TransAmSpeedcastClientProtocol | Broadcast Server -> TransAm |
| | Game Client conversation |
| (ACCP) ArenaClientChatProtocol | Chat Server -> Game |
| | Client chat conversation |
| (AACP) AMASBArenaClientProtocol | Game Server -> AMASB |
| | Game Client conversation |
| (NACP) NHRXArenaClientProtocol | Game Server -> NHRA |
| | Game Client conversation |
| (TACP) TransAmArenaClientProtocol | Game server -> TransAm |
| | Game Client conversation |

One or more of the arena client hub protocols support the following features and capabilities:

Client Registration—Account Creation, personal data editing, reception of client membership file (pit pass)

Client Authentication

Online/Offline play selection

Game Skill Level Selection

Game Vehicle Type Selection

Game Vehicle Selection

Game Event Selection

Spectator broadcast Event Selection

Chat Room Selection and Chat Support

Player Connection Quality indication

Series Event Schedule Advertising and sign-up support

Standings and Scores Display Driver

Banner/Flash Advertising Display Driver

Hub 12 may provide one or more of the following services:

Authenticate and register game servers that connect to the game network, providing them with tasks (events) to perform, the times and the initialization data required to perform those events. This initialization data is read from tables (records) contained within RDBMS 38. For example, games such as AMASuperBike, NHRA Drag Racing, TransAM, and/or the like.

Authenticate game clients, for example, AMASuperBike, NHRA Drag Racing, TransAM, and/or the like, that connect to the game network, providing these clients with lists of currently available events for the user to select from and play. Supply information in real-time about the currently selected event (such as current weather and occupancy) and also show the names of the occupants that are competing in each event. Once a event selection is made, the hub assists in getting the client connected to the proper game server, chat server, chat room and channel, etc., then records user usage statistics, such as the time of connection, user permissions and the players IP address to the statistical database table. The Player User Interface of AMASuperBike is preferably designed as an in-game C/C++ interface while the NHRA Drag Racing game interface is developed as a Browser Applet using JAVA. The hub protocols are completely compatible with either game UI design method.

Authenticate and register chat servers that connect to the game network, providing them with the initialization data desirable to perform their tasks.

Authenticate and register broadcast servers that connect to the game network, providing them with initialization data desirable to perform their tasks.

Provide a secure administration interface used to maintain and edit such things as client account records, game event records, event schedules, view usage statistics, etc.

At event completion, compute each competitors score and statistics and write them to RDBMS 38. Then compile and send event scoring reports to competitors who competed in a particular event. These scoring reports are emailed to each competitor, if requested, via the SMTP protocol.

Monitor the health of servers connected to the hub and alert the system administrator if any server fails to respond within a prescribed time limit.

Game servers and chat servers may be located anywhere in the world, including user machines.

RDBMS Server 38

The primary role of authentication server 24 is to authenticate clients. Each client is authenticated against a record of the customer ID and password stored in RDBMS 38.

DBConnectionBroker

A connection pool is a cache of open connections (sockets) to RDBMS 38. The connections are preferably handed out in round-robin order to a servlet requesting a database connection. Relational data base systems are usually slow (2-5 seconds) in establishing a TCP connection. By keeping a pool of already open connections, servlets like the hub that do extensive database access, execute much faster than if they attempted to request a connection from the database directly. The connection pool class is referred to as DBConnectionBroker.

The database connection broker resides in it's own thread and also starts a secondary housekeeping thread, who's job is to clean up open statements (SQL programming errors which don't properly close result sets). It is initialized as soon as the hub starts. The connection broker used by authentication server 24 is not the only instance of a connection pool used on the network.

JDBC Drivers

JDBC drivers are a set of drivers for Java to communicate with an MSQL database.

Authentication Hub 24

After the connection pool is started authentication hub 24 preferably starts a plurality of threads of execution. One thread waits for game client connections, one waits for game server connections, one waits for broadcast server connections and one for chat server connections. For each game client that connects to the ArenaClientHub, a new handler thread is spawned. Likewise for each game server that connects to the game server hub, broadcast server that connects to the broadcast server hub, or chat server that connects to the chat server hub, a new handler thread is created. Within each newly spawned handler thread reside a socket (connection) object, an input stream object, an output stream object and a protocol object, capable of interpreting the command messages entering via the input stream, providing responses via the output stream and maintaining protocol state. All of these conversations reside in a unique thread, so they can take place simultaneously over these socket connections. When a conversation terminates, the socket associated with the handler thread is closed the connection, input, output and protocol objects are deleted and then the thread is subsequently terminated.

Game User Interface Driver 22

Authenticates game clients, then provides them with the list of games available to choose from, the names of the competitors in each game, and a means of reserving a slot in the game which they select. When the client selects a game, the client hub hands the message over to the chat server hub, which in turn contacts the chat server and changes the room and channel to that specified by the game instance template. When the client joins a game, the hub contacts the specified game server and reserves a slot in that game, if possible (i.e., if the game has space available and is not in progress). The game server in turn supplies the hub with an encrypted packet containing the successful reservation ticket containing the IP Address and Port to connect to or denial reason. A similar mechanism supplies the client with the IP Address and Port of the chat server to connect to, soon after client authentication. This permits the actual chat server and game server locations to be dynamic, not fixed to any specific IP or port permitting these servers to reside at any location in the world.

Game Server Hub 26

Authenticates game servers and provides a path for these servers to exchange data with RDBMS 38. Game server hub 26 re-initializes each server with data read from RDBMS 38, after each event completes and writes out final statistics data through this same hub connection. Game server hub 26 is also the entry point for administration commands, since it is preferably a servlet, capable of displaying all executing games and handling administrative commands directed at those games.

Chat Server Hub 28

Authenticates chat servers and provides clients with a means of reserving a slot in the chat room they select, and provides room and channel selection facilities. When the client selects a game, the hub contacts the chat server and changes the room and channel to that specified by the game template for the selected game. Chat server hub 28 is also the entry point for administrative commands, since chat server hub 28 is preferably a servlet, capable of displaying all executing chat servers and handling administrative commands directed at those servers.

Broadcast Server Hub 30

Authenticates broadcast servers and provides clients with a means of reserving a slot in the broadcast server that supports the game. When the game client selects a game, the broadcast server hub contacts the broadcast server which allocates a broadcast stream connection to the selected game, for the particular game client. Broadcast server hub 30 is preferably a servlet, capable of displaying all executing broadcast servers and handling administrative commands directed at those servers.

ArenaServerHubProtocol

This is the protocol between game server hub 26 and game server 14 that authenticates the game server to the game server hub. Once the game server is authenticated the game server hub supplies initialization information to the game server which makes a generic game server into a game server for a specific event. The initialization information comprises information, such as the event, event name, weather parameters, number of players that can participate in the event, and/or the like.

ArenaClientHubProtocol

This is the protocol over which a game client is authenticated and permitted to join the game network. When the client selects a game from the list of available games, he sends a reservation request off to the hub. The reservation request comprises of the session ID.

ArenaClientProtocol

Game client side packet interpreter responsible for conversation between the game client and the game server.

ArenaServerProtocol

Game server side packet interpreter responsible for conversation between the game server and the game client.

The present invention may be implemented in software, hardware, or a combination of both software and hardware. The software and/or hardware may reside on hub 12, game server 14 and/or game client 32.

If desired, the different steps discussed herein may be performed in any order and/or concurrently with each other. Furthermore, if desired, one or more of the above described steps may be optional or may be combined without departing from the scope of the present invention.

While the invention has been particularly shown and described by the foregoing detailed description, it will be understood by those skilled in the art that various other changes in form and detail may be made without departing from the spirit and scope of the invention.

[image]

[image]

[image]

[image]

[image]

[image]

[image]

[image]

[image]

[image]

[image]

[image]

What is claimed is:

1. A method for rendering graphics image data in real-time for a plurality of game clients, comprising:
receiving a packet from a first one of said plurality of game clients, said packet comprising a packet header comprising a time-stamp of transmission of said packet from said first game client and a client time differential between a clock of said first game client and a clock of a game server;
determining a time-stamp of reception of said packet by said game server;
determining time taken by said packet to arrive from said first game client to said game server;
rendering graphics image data based at least in part on said time taken by said packet to arrive at said game server; and
providing said rendered graphics image data to a second one of said plurality of game clients.

2. The method of claim 1, wherein said providing step comprises transmitting a packet from said game server to said second game client, said packet comprising a packet header comprising a time-stamp of transmission of said packet from said game server and a server time differential between said clock of said game server and a clock of said second game client.

3. The method of claim 1, further comprising:
determining time taken by a packet to arrive from said second game client to said game server;
rendering graphics image data based at least in part on said time taken by said packet to arrive from said second game client to said game server; and
providing said rendered graphics image data to said first game client.

4. The method of claim 3, wherein said providing step comprises transmitting a packet from said game server to said first game client, said packet comprising a packet header comprising a time-stamp of transmission of said packet from said game server and a server time differential between said clock of said game server and a clock of said first game client.

5. A method for rendering graphics image data in real-time for a plurality of game clients, comprising:
receiving a plurality of packets from said plurality of game clients, each of said plurality of packets comprising a packet header comprising a time-stamp of transmission of said packet from respective ones of said plurality of game clients and a client time differential between a clock of respective ones of said plurality of game clients and a clock of a game server;
determining a time-stamp of reception of each of said plurality of packets by said game server;
determining time taken by said plurality of packets to arrive from respective ones of said plurality of game clients to said game server;
rendering a plurality of images, each of said plurality of images corresponding to at least one of said plurality of game clients, based at least in part on said time taken by at least one of said plurality of packets to arrive at said game server; and
providing at least one of said plurality of images to at least one of said plurality of game clients.

6. The method of claim 5, wherein said providing step comprises transmitting said at least one image as a plurality of data packets to said at least one game client, each data packet comprising a packet header comprising a time-stamp of transmission of said data packet from said game server and a server time differential between said clock of said game server and a clock of said at least one game client.

7. A method for synchronizing a clock of a game server and a clock of a game client, comprising:
receiving a first packet from said game client, said first packet comprising a packet header comprising a time-stamp of transmission of said first packet from said game client and a client time differential between said clock of said game client and said clock of said game server;
determining a time-stamp of reception of said first packet by said game server;
determining time taken by said first packet to arrive from said game client to said game server;
calculating a server time differential between said clock of said game client and same clock of said game server based at least in part on said time-stamp of reception of said first packet and at least in part on said time-stamp of transmission of said first packet; and
transmitting a second packet from said game server, said second packet comprising a packet header comprising a time-stamp of transmission of said second packet from said game server and said server time differential.

8. The method of claim 7, further comprising:
determining a time-stamp of reception of said second packet by said game client;
determining time taken by said second packet to arrive from said game server to said game client;
calculating said client time differential between said clock of said game client and said clock of said game server based at least in part on said time-stamp of reception of said second packet and at least in part on said time-stamp of transmission of said second packet; and
transmitting a third packet from said game client, said third packet comprising a packet header comprising a time-stamp of transmission of said third packet from said game client and said client time differential between said clock of said game client and said clock of said game server.

9. The method of claim 7, further comprising:
rendering graphics image data based at least in part on said time taken by said packet to arrive at said game server; and
providing said rendered graphics image data to a second game client.

10. A video game system, comprising:
a game server operable to receive a first packet from a game client, said first packet comprising a packet header comprising a time-stamp of transmission of said first packet from said game client and a client time differential between said clock of said game client and said clock of said game server, said game server operable to:
determine a time-stamp of reception of said first packet by said game server;
determine time taken by said first packet to arrive from said game client to said game server;
calculate a server time differential between said clock of said game client and same clock of said game server based at least in part on said time-stamp of reception of said first packet and at least in part on said time-stamp of transmission of said first packet; and
transmit a second packet from said game server, said second packet comprising a packet header comprising a time-stamp of transmission of said second packet from said game server and said server time differential.

11. The video game system of claim 10, wherein said game server is operable to:
determine a time-stamp of reception of said second packet by said game client;
determine time taken by said second packet to arrive from said game server to said game client;
calculate said client time differential between said clock of said game client and said clock of said game server based at least in part on said time-stamp of reception of said second packet and at least in part on said time-stamp of transmission of said second packet; and
transmit a third packet from said game client, said third packet comprising a packet header comprising a time-stamp of transmission of said third packet from said game client and said client time differential between said clock of said game client and said clock of said game server.
